(19) United States
(12) Patent Application Publication
(10) Pub. No.: US 2025/0166263 A1
(43) Pub. Date: May 22, 2025

(54) METHOD AND APPARATUS WITH BLIND FACE RESTORATION

(71) Applicant: Samsung Electronics Co., Ltd., Suwon-si (KR)

(72) Inventor: Hui LI, Xi’an (CN)

(73) Assignee: Samsung Electronics Co., Ltd., Suwon-si (KR)

(21) Appl. No.: 18/947,278

(22) Filed: Nov. 14, 2024

(30) Foreign Application Priority Data
Nov. 17, 2023 (CN) 202311540744.8
Sep. 26, 2024 (KR) 10-2024-0130804

(51) Int. Cl. G06T 11/60; G06T 3/40; G06T 5/50; G06V 10/80; G06V 40/16

(52) U.S. Cl. CPC G06T 11/60; G06T 3/40; G06T 5/50; G06V 10/806; G06V 40/168; G06T 2207/10024; G06T 2207/20016; G06T 2207/20221

(57) ABSTRACT

A processor-implemented method including obtaining a pyramid feature of an input face image, generating a first initial style feature corresponding to a highest level feature based on the highest level feature of the pyramid feature, and a latent code and noise of the input face image, generating a first style feature corresponding to each level feature based on an integrated feature corresponding to each level feature of the pyramid feature, the noise, and the latent code, and generating a high-quality face image of the input face image based on the first initial style feature and the first style feature corresponding to each level feature of the pyramid feature, the integrated feature corresponding to each level feature is generated based on each level feature, the first style feature corresponding to a higher level feature of each level feature, the latent code, and the noise and an integrated feature corresponding to the highest level feature of the pyramid feature is generated based on the highest level feature, the latent code, the noise, and the first initial style feature.

### CROSS-REFERENCE TO RELATED APPLICATIONS

This application claims the benefit under 35 USC § 119(a) of Chinese Patent Application No. 202311540744.8 filed on Nov. 17, 2023, in the China National Intellectual Property Administration, and Korean Patent Application No. 10-2024-0130804 filed on Sep. 26, 2024, in the Korean Intellectual Property Office, the entire disclosures of which are incorporated herein by reference for all purposes.

### BACKGROUND

### 1. Field

The following description relates to the field of image processing, and more particularly, to a method and apparatus for blind face restoration (BFR).

### 2. Description of Related Art

Blind face restoration (BFR) is a technology for restoring a low-quality face image with unknown degradation (e.g., noise, blur, down-sampling, etc.). Typically, image generating quality may be improved by assuming the BFR as a conditional image generation problem and using various types of priors (e.g., a generative prior and a reference prior).

With the advancement of a generative adversarial network (GAN), in many typical methods, the powerful generative ability of a pre-trained StyleGAN model is used to generate realistic textures. This method typically involves reprojecting a degraded image into a GAN latent space and then decoding a high-quality face with a pre-trained generator.

The above method may generate a realistic face, but it fails to maintain delicate facial features of an input image, and, as a result, a high-quality face may be generated but the generated face may be different from the original object. For example, the typical GAN method uses rich and diverse prior information of the pre-trained GAN as a latent library to improve the quality of super-resolution (SR) images and generate realistic facial details. However, the GAN prior network is individually pre-trained on a specific dataset, and therefore, the generated face identity may be affected when the GAN prior is used on another test dataset. Since the high-quality code sets or dictionaries are generated from different data sets, the same problem may occur when using the reference prior. In addition, since existing techniques do not use any prior BFR method, higher fidelity may be obtained, however, the generated image may not be smooth.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including obtaining a pyramid feature of an input face image, generating a first initial style feature corresponding to a highest level feature based on the highest level feature of the pyramid feature, and a latent code and noise of the input face image, generating a first style feature corresponding to each level feature based on an integrated feature corresponding to each level feature of the pyramid feature, the noise, and the latent code, and generating a high-quality face image of the input face image based on the first initial style feature and the first style feature corresponding to each level feature of the pyramid feature, the integrated feature corresponding to each level feature is generated based on each level feature, the first style feature corresponding to a higher level feature of each level feature, the latent code, and the noise and an integrated feature corresponding to the highest level feature of the pyramid feature is generated based on the highest level feature, the latent code, the noise, and the first initial style feature.

The method may include generating a second style feature corresponding to the higher level feature based on the first style feature corresponding to the higher level feature, the noise, and the latent code, generating the integrated feature corresponding to each level feature based on the second style feature corresponding to the higher level feature, and each level feature, and generating a second initial style feature corresponding to the highest level feature based on the first initial style feature, the latent code, and the noise, and generating the integrated feature corresponding to the highest level feature based on the second initial style feature and the highest level feature.

The generating of the integrated feature corresponding to each level feature based on the second style feature corresponding to the higher level feature, and each level feature may include generating a first fully connected feature of the second style feature corresponding to the higher level feature and a first fully connected feature of each level feature by performing a full connection for each of the second style feature corresponding to the higher level feature, and each level feature, generating a first feature by performing first weighted summation of the first fully connected feature of the second style feature corresponding to the higher level feature and the first fully connected feature of each level feature, generating a second feature by performing the full connection for the first feature, and generating the integrated feature corresponding to each level feature based on the second feature, and the generating of the integrated feature corresponding to the highest level feature based on the second initial style feature and the highest level feature may include generating a first fully connected feature of the second initial style feature and a first fully connected feature of the highest level feature by performing the full connection for each of the second initial style feature and the highest level feature, generating a third feature by performing second weighted summation of the first fully connected feature of the second initial style feature and the first fully connected feature of the highest level feature, generating a fourth feature by performing the full connection for the third feature, and obtaining the integrated feature corresponding to the highest level feature based on the fourth feature.

A first weight of the first weighted summation for generating the first feature may be obtained based on the second style feature corresponding to the higher level feature and a second weight of the second weighted summation for generating the third feature is obtained based on the second initial style feature.

The method may include generating the first weight by performing a softmax operation for the first fully connected feature corresponding to the second style feature corresponding to the higher level feature and generating the second weight by performing the softmax operation for a second fully connected feature corresponding to the second initial style feature.

The generating of the high-quality face image of the input face image based on the first initial style feature and the first style feature corresponding to each level feature of the pyramid feature may include obtaining a red, green, blue (RGB) image corresponding to each level feature based on the first style feature corresponding to each level feature of the pyramid feature, and obtaining an initial RGB image corresponding to the highest level feature based on the first initial style feature and generating a cumulative RGB image corresponding to each level feature by summing the RGB image corresponding to each level feature and an upscaled RGB image corresponding to the higher level feature of each level feature, a cumulative RGB image corresponding to a lowest level feature may be a high-quality image, the upscaled RGB image corresponding to each level feature may be generating by upscaling the cumulative RGB image corresponding to each level feature, and a cumulative RGB image corresponding to the highest level feature may be generating by summing an RGB image corresponding to the highest level feature and an image obtained by upscaling the initial RGB image corresponding to the highest level feature.

The method may include generating the latent code by performing convolution and full connection for the highest level feature.

In a general aspect, here is provided a non-transitory computer-readable storage medium storing instructions that, when executed by a processor, cause the processor to perform the method.

In a general aspect, here is provided an apparatus including a pyramid feature obtaining processing element configured to obtain a pyramid feature of an input face image, a first style feature obtaining processing element configured to generate a first initial style feature corresponding to a highest level feature based on the highest level feature of the pyramid feature, and a latent code and noise of the input face image, and generate a first style feature corresponding to each level feature based on an integrated feature corresponding to each level feature of the pyramid feature, the noise, and the latent code, and a face image obtaining processing element configured to generate a high-quality face image of the input face image based on the first initial style feature and the first style feature corresponding to each level feature of the pyramid feature, the integrated feature corresponding to each level feature is obtained based on each level feature, the first style feature corresponding to a higher level feature of each level feature, the latent code, and the noise and an integrated feature corresponding to the highest level feature of the pyramid feature is generated based on the highest level feature, the latent code, the noise, and the first initial style feature.

The apparatus may include a second style feature obtaining processing element configured to generate a second style feature corresponding to the higher level feature based on the first style feature corresponding to the higher level feature, the noise, and the latent code, generate the integrated feature corresponding to each level feature based on the second style feature corresponding to the higher level feature, and each level feature, generate a second initial style feature corresponding to the highest level feature based on the first initial style feature, the latent code, and the noise, and generate the integrated feature corresponding to the highest level feature based on the second initial style feature and the highest level feature.

The second style feature obtaining processing element may be configured to generate a first fully connected feature of the second style feature corresponding to the higher level feature and a first fully connected feature of each level feature by performing a full connection for each of the second style feature corresponding to the higher level feature, and each level feature, generate a first feature by performing first weighted summation of the first fully connected feature of the second style feature corresponding to the higher level feature and the first fully connected feature of each level feature, generate a second feature by performing the full connection for the first feature, generate the integrated feature corresponding to each level feature based on the second feature, generate a first fully connected feature of the second initial style feature and a first fully connected feature of the highest level feature by performing the full connection for each of the second initial style feature and the highest level feature, generate a third feature by performing second weighted summation of the first fully connected feature of the second initial style feature and the first fully connected feature of the highest level feature, generate a fourth feature by performing the full connection for the third feature, and obtain the integrated feature corresponding to the highest level feature based on the fourth feature.

A first weight of the first weighted summation for generating the first feature may be obtained based on the second style feature corresponding to the higher level feature and a second weight of the second weighted summation for obtaining the third feature may be obtained based on the second initial style feature.

The apparatus may include a weight obtaining processing element configured to generate the first weight by performing a softmax operation for the first fully connected feature corresponding to the second style feature corresponding to the higher level feature and generate the second weight by performing the softmax operation for a second fully connected feature corresponding to the second initial style feature.

The face image obtaining processing element may be configured to obtain a red, green, blue (RGB) image corresponding to each level feature based on the first style feature corresponding to each level feature of the pyramid feature, generate an initial RGB image corresponding to the highest level feature based on the first initial style feature, and generate a cumulative RGB image corresponding to each level feature by summing the RGB image corresponding to each level feature and an upscaled RGB image corresponding to the higher level feature of each level feature, a cumulative RGB image corresponding to a lowest level feature may be a high-quality image, the upscaled RGB image corresponding to each level feature may be generated by upscaling the cumulative RGB image corresponding to each level feature, and a cumulative RGB image corresponding to the highest level feature is generated by summing an RGB image corresponding to the highest level feature and an image generated by upscaling the initial RGB image corresponding to the highest level feature.

The apparatus may include a latent code obtaining processing element configured to generate the latent code by performing convolution and full connection for the highest level feature.

In a general aspect, here is provided an electronic device including one or more processors configured to execute instructions and a memory storing the instructions, and an execution of the instructions configures the processors to obtain a pyramid feature of an input face image, generate a first initial style feature corresponding to a highest level feature based on the highest level feature of the pyramid feature, and a latent code and noise of the input face image, generate a first style feature corresponding to each level feature based on an integrated feature corresponding to each level feature of the pyramid feature, the noise, and the latent code, and generate a high-quality face image of the input face image based on the first initial style feature and the first style feature corresponding to each level feature of the pyramid feature, the integrated feature corresponding to each level feature being generated based on each level feature, the first style feature corresponding to a higher level feature of each level feature, the latent code, and the noise and an integrated feature corresponding to the highest level feature of the pyramid feature being generated based on the highest level feature, the latent code, the noise, and the first initial style feature.

Other features and aspects will be apparent from the following detailed description, the drawings, and the claims.

### BRIEF DESCRIPTION OF THE DRAWINGS

FIG. 1 illustrates an example method of restoring a blind face according to one or more embodiments.

FIG. 2 illustrates an example apparatus for restoring a blind face according to one or more embodiments.

FIG. 3 illustrates an example process of generating a style feature and generating a high-quality image based on the style feature according to one or more embodiments.

FIG. 4 illustrates an example process of generating a feature of each level or an integrated feature corresponding to a highest level feature according to one or more embodiments.

FIG. 5 illustrates an example apparatus for restoring a blind face according to one or more embodiments.

FIG. 6 illustrates an example electronic apparatus according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Examples of the present disclosure may improve the quality of the generated image while ensuring facial identity over typical blind face restoration (BFR) methods.

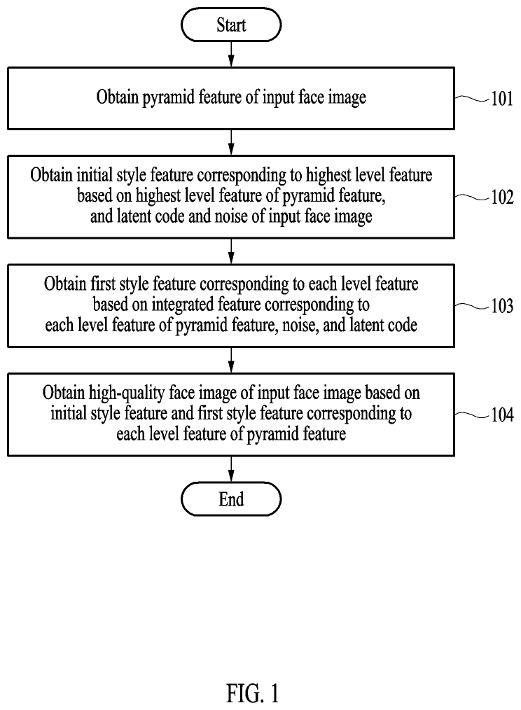

FIG. 1 illustrates an example method for restoring a blind face according to one or more embodiments.

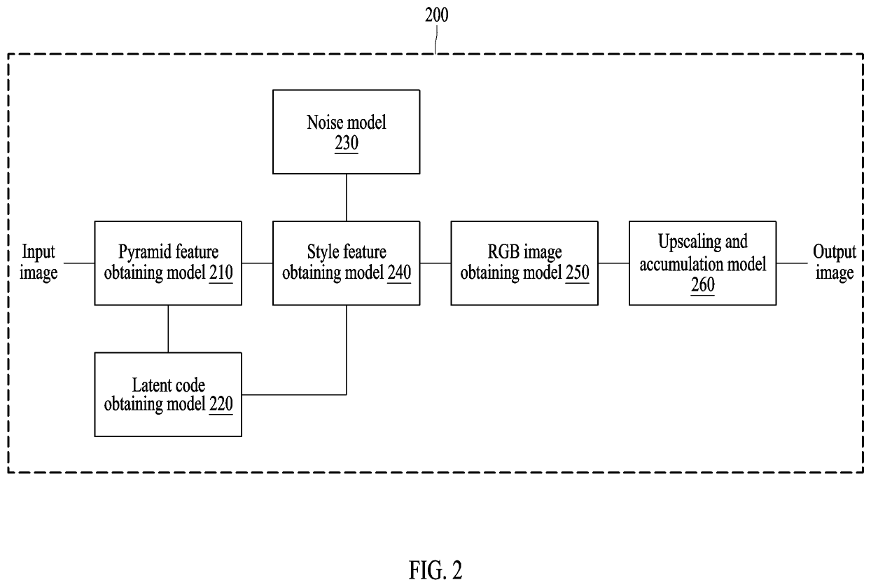

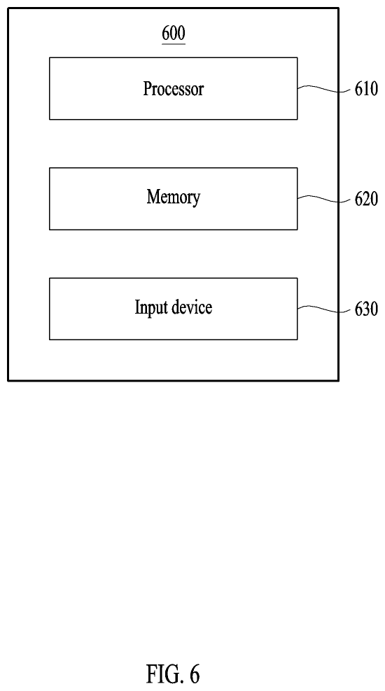

Referring to FIG. 1, in a non-limiting example, a BFR method may be performed by a face restoring apparatus (e.g., face restoring apparatus 200 of FIG. 2 or electronic apparatus 600 of FIG. 6). In an example, operation 101, the BFR method may include obtaining a pyramid feature of an input face image.

In an example, in operation 102, the BFR method may include generating an initial style feature corresponding to a highest level feature based on the highest level feature of the pyramid feature, and a latent code and noise of the input face image.

In an example, in operation 103, the BFR method may include generating a first style feature corresponding to each level feature based on an integrated feature corresponding to each level feature of the pyramid feature, the noise, and the latent code. Here, the integrated feature corresponding to each level feature may be generated based on each level feature, the first style feature corresponding to a higher level feature of each level feature, the latent code, and the noise. An integrated feature corresponding to the highest level feature of the pyramid feature may be generated based on the highest level feature, the latent code, the noise, and the first initial style feature.

Each level feature of operation 103 may represent a specific level feature of the pyramid feature, but does not necessarily represent all level features of the pyramid feature. For example, the first style feature corresponding to a fourth level feature may be generated based on the integrated feature, the noise, and the latent code corresponding to the fourth level feature of the pyramid feature, and the integrated feature corresponding to the fourth level feature may be generated based on the fourth level feature, the first style feature corresponding to a higher level feature (i.e., a third level feature) of the fourth level feature, the latent code, and the noise.

In an example, the BFR method may include generating a second style feature corresponding to the higher level feature based on the first style feature corresponding to the higher level feature, the noise, and the latent code. The BFR may also include generating the integrated feature corresponding to each level feature based on the second style feature corresponding to the higher level feature, and each level feature.

The BFR method may include generating a second initial style feature corresponding to the highest level feature based on the first initial style feature corresponding to the highest level feature, the latent code, and the noise. The BFR may also include generating the integrated feature corresponding to the highest level feature based on the second initial style feature and the highest level feature.

In an example, in operation 104, the BFR method may include generating a high-quality face image corresponding to the input face image based on the first initial style feature and the first style feature corresponding to all level features of the pyramid feature.

For example, since the style feature contain good texture information for generating real facial details, a high-quality image generated by fusing the style feature and a feature (that is, the pyramid feature of all levels) encoded using the generated style feature as a guide may not only help to preserve the facial identity, but may also improve the image generation quality by removing noise from the encoded feature.

In an example, operation 104 may include obtaining a red, green, blue (RGB) image corresponding to each level feature based on the first style feature corresponding to each level feature of the pyramid feature, generating an initial RGB image corresponding to the highest level feature based on the first initial style feature, and generating a cumulative RGB image corresponding to each level feature by summing the RGB image corresponding to each level feature and an upscaled RGB image corresponding to the higher level feature of each level feature. The upscaled RGB image corresponding to each level feature may be generated by upscaling the cumulative RGB image corresponding to each level feature. The cumulative RGB image corresponding to the highest level feature may be generated by summing an RGB image corresponding to the highest level feature and an image generated by upscaling the initial RGB image corresponding to the highest level feature. For example, the cumulative RGB image corresponding to a lowest level feature may be a high-quality image.

In an example, the BFR method may include generating a weight of a first weighted summation by performing a softmax operation for the first fully connected feature corresponding to the second style feature corresponding to the higher level feature. The BFR may also include generating a weight of second weighted summation by performing the softmax operation for a second fully connected feature corresponding to the second initial style feature. Next, the softmax operation may make the sum of the weight values l and ensure a size relationship between the weight values, so that the change in the original data due to the weight operation may be made more reasonable. The method of generating the weight of the weighted sum based on the softmax operation is an example and does not limit the present disclosure.

FIG. 2 illustrates an example apparatus for restoring a blind face according to one or more embodiments.

Referring to FIG. 2, in a non-limiting example, a face restoring apparatus 200 may perform a method (e.g., the BFR method of FIG. 1) of restoring a blind face. In an example, the face restoring apparatus may include a pyramid feature obtaining model 210, a latent code obtaining model 220, a noise model 230, a style feature obtaining model 240, an RGB image obtaining model 250, and an upscaling and accumulation model 260.

When a face image is input, the pyramid feature obtaining model 210 may obtain a pyramid feature from the input face image. In an example, the pyramid feature obtaining model 210 may include a plurality of cascaded convolutional layers for obtaining or generating the pyramid feature. For example, the stride of each convolutional layer may be 2, and a size of a convolutional kernel may be 3. The pyramid feature may be denoted as fₗ₊₄, . . . , fₗ₊₁, fₗ, where l represents the logarithm of a feature size with the base 2, for example, the size of fₗ is 2^{l}.

In an example, the pyramid feature obtaining model 210 may obtain pyramid features of five levels using five cascaded convolutional layers. Here, a highest level feature (i.e., a top level feature) is fₗ, a lowest level feature (i.e., a bottom level feature) is fₗ₊₄, and herein, l=4. Those skilled in the art may understand that the pyramid feature is an example and does not limit the present disclosure.

A higher level feature of a specific level feature of the pyramid feature described here may represent a feature lower than the specific level feature that is adjacent to the specific level feature. For example, in the pyramid feature, a higher level feature of the fifth level feature is the fourth level feature, and the fifth level feature may be obtained (i.e., generated) based on the fourth level feature.

In an example, the latent code obtaining model 220 may obtain a latent code.

In an example, the latent code obtaining model 220 may include cascaded convolutional layers and fully connected layers, and may generate the latent code of the input face image by performing convolution and full connection for the highest level feature.

In an example, the noise model 230 may generate noise. For example, the noise may be Gaussian white noise. However, Gaussian white noise is one example of noise and does not limit the present disclosure. The noise is added because many features of a human face, such as wrinkles and hair, are random. An image generated by adding noise may be output more vividly and in various ways.

In an example, the style feature obtaining model 240 may obtain an initial style feature and a corresponding first style feature.

In an example, the RGB image obtaining model 250 may obtain an initial RGB image corresponding to the highest level feature and an RGB image corresponding to all level features of the pyramid feature.

The RGB image obtaining model 250 may include a toRGB layer corresponding to a first initial style feature corresponding to the highest level feature and the first style feature corresponding to all level features of the pyramid feature. The RGB image obtaining model 250 may generate an RGB image corresponding to each level feature with the corresponding toRGB layer based on the first style feature corresponding to each level feature of the pyramid feature, and generate an initial RGB image corresponding to the highest level feature with the corresponding toRGB layer based on the first initial style feature.

In an example, the upscaling and accumulation model 260 may perform an accumulation operation to generate a high-quality image corresponding to the input face image.

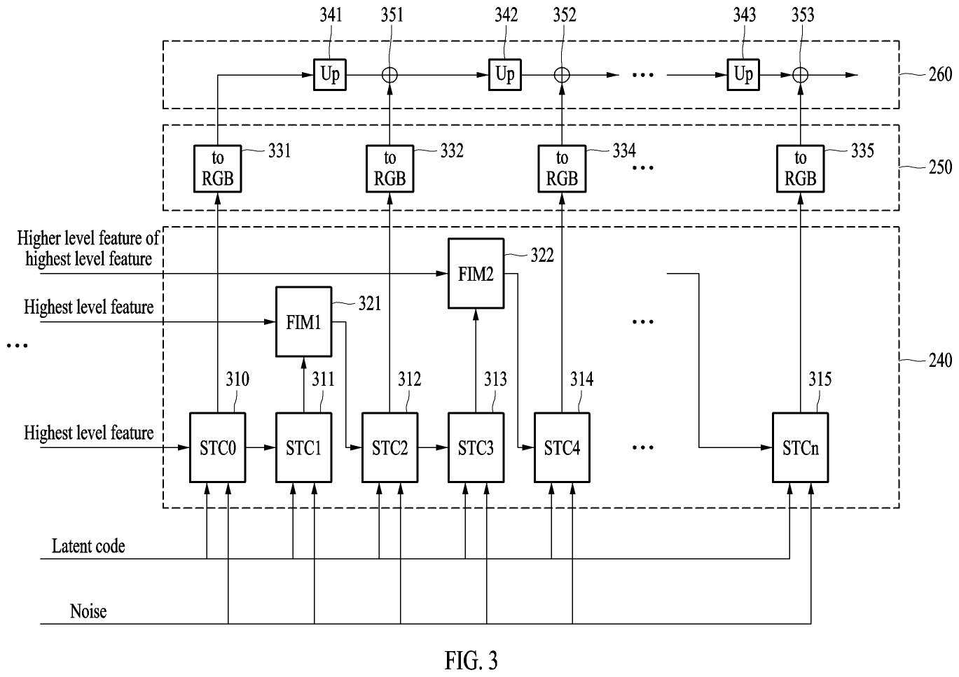

FIG. 3 illustrates an example process of generating a style feature and generating a high-quality image based on the style feature according to one or more embodiments.

Referring to FIG. 3, in a non-limiting example, the BFR method may include generating an integrated feature corresponding to each level feature by using one or more feature integration models (FIM) (e.g., FIM1 321 and FIM2 322). For example, the FIM1 321 may be used to generate an integrated feature corresponding to the highest level feature (i.e., the fifth level feature), and the FIM2 322 may be used to generate an integrated feature corresponding to the next level below the highest level (i.e., the fourth level feature).

In an example, the BFR method may include generating the first style feature corresponding to all level features of the pyramid feature and/or the initial style feature corresponding to the highest level feature by using corresponding style convolutional layers (or models) (e.g., STC0 to STCn 310, 311, 312, 313, 314, and 315). For example, the BFR method may include generating the first style feature corresponding to the fifth level feature (i.e., the highest level feature or the top level feature, the size of which being 16) with a style convolutional (StyleConv) layer (STC2 312), generating the first style feature corresponding to the fourth level feature with a style convolutional layer (STC4 314), and generating the initial style feature with a style convolutional layer (STC0 310).

In an example, the BFR method may include generating a second style feature corresponding to the fifth level feature with a style convolutional layer (STC3 313) based on the first style feature corresponding to the fifth level feature, the latent code, and the noise. The BFR may also include generating an integrated feature corresponding to the fourth level feature with the FIM2 322 based on the second style feature corresponding to the fifth level feature and the fourth level feature. In addition, the BFR method may also include generating the integrated features corresponding to features from the first to third levels. The BFR method may include generating a second initial style feature corresponding to the highest level feature with the style convolutional layer (STC1 311) based on the first initial style feature, the latent code, and the noise, and may include generating the integrated feature corresponding to the highest level feature with the FIM1 321 based on the second initial style feature and the highest level feature.

The convolution operation, the style convolutional layers (e.g., STC0 to STCn 310, 311, 312, 313, 314, and 315), and the style convolution model may have the same or similar meanings as a style convolution operation, a style convolutional layer, and a style convolution model of StyleGAN.

In an example, the style convolutional layer may include a Mod std layer, an upsampling layer, a convolutional layer, and a Norm std layer. Here, the Mod std layer may represent a cascaded linear layer and a normalization layer, and the Norm std layer may represent a normalized standard layer.

In an example, the STC0 310, the STC2 312, and the STC4 314 may include the Mod std layer, the convolutional layer, and the Norm std layer.

In an example, the STC0 310, the STC2 312, and the STC4 314, and the STC1 311, STC3 313, and the STC5 315 may have the same or similar structure as the corresponding style convolutional layers of StyleGAN, and a detailed description thereof will be omitted.

In an example, when the integrated feature corresponding to each level feature is obtained based on the second style feature corresponding to the higher level feature and each level feature, the BFR method may include generating the integrated feature corresponding to each level feature by cascading or summing the second style feature corresponding to the higher level feature and each level feature.

In an example, the BFR method may include one or more processes to refine a style and integrated features for blind face restoration. In a first process, when the integrated feature corresponding to each level feature is generated based on the second style feature corresponding to the higher level feature and each level feature, the BFR method may include generating a first fully connected feature of the second style feature corresponding to the higher level feature and a first fully connected feature of each level feature by performing a full connection for each of the second style feature corresponding to the higher level feature, and each level feature. Next, the BFR may include generating a first feature by performing weighted summation of the first fully connected feature of the second style feature corresponding to the higher level feature and the first fully connected feature of each level feature. The BFR method may next generate a second feature by performing the full connection for the first feature. Finally, the BFR may include generating the integrated feature corresponding to each level feature based on the second feature.

In an example, when the integrated feature corresponding to the highest level feature is generated based on the second initial style feature and the highest level feature, the BFR method may include generating a first fully connected feature of the second initial style feature and a first fully connected feature of the highest level feature by performing the full connection for each of the second initial style feature and the highest level feature. The BFR may also include generating a third feature by performing weighted summation of the first fully connected feature of the second initial style feature and the first fully connected feature of the highest level feature. The BFR may also include generating a fourth feature by performing the full connection for the third feature and obtaining the integrated feature corresponding to the highest level feature based on the fourth feature. Next, the weight of the second weighted summation to generate the third feature may be obtained based on the second initial style feature.

In an example, the first weight of the weighted summation to generate the first feature may be obtained based on the second style feature corresponding to the higher level feature. Here, the weight of the second weighted summation to generate the third feature may be obtained based on the second initial style feature.

In an example, the BFR method may include performing the above-described upscaling operation through upsampling (UP) layers 341, 342, and 343 of FIG. 3.

In an example, the BFR method may include generating a cumulative RGB image corresponding to each level feature by summing the RGB image corresponding to each level feature and the upscaled RGB image corresponding to the higher level feature of each level feature through adders 351, 352, and 353.

In an example, each of toRGB layers 331, 332, 334, and 335 as used in StyleGAN may be a single convolutional layer (with a convolution kernel size of 1), which may convert the features input to the toRGB layer 331, 332, 334, and 335 into three channels (i.e., three channels of R, G, and B). The upscaling size of the UP layers 341, 342, and 343 may be 2.

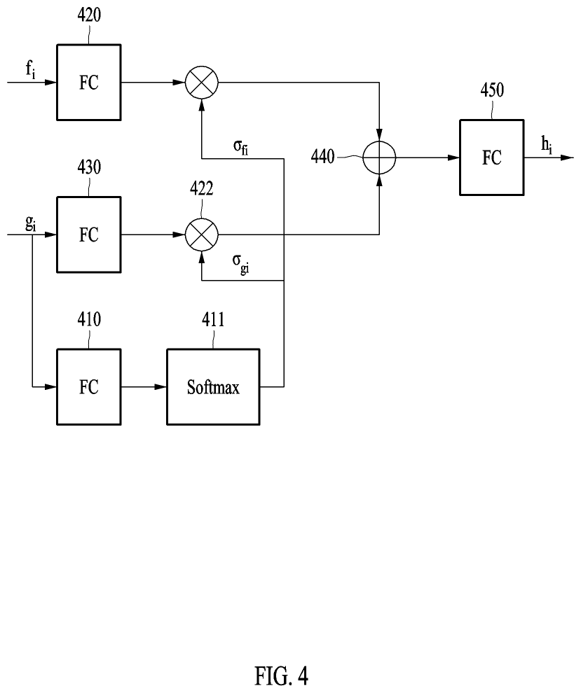

FIG. 4 illustrates an example process of generating a feature of each level or an integrated feature corresponding to a highest level feature according to one or more embodiments.

More specifically, FIG. 4 illustrates a process (i.e., an FIM operation) of generating an integrated feature corresponding to each level feature based on a second style feature, the second style feature corresponding to a next higher level feature for each level feature in addition to each level feature. Here, the integrated feature of the higher level feature is obtained based on the second initial style feature and the highest level feature.

Referring to FIG. 4, in a non-limiting example, the FIM operation may include one or more fully connected layers (FC) 410, 420, 430, and 450, a multiplier 421 and 422, a softmax 411, and an adder 440. In addition, in an example, an integrated feature of the FIM operation may be implemented in the form of <Equation 1> below using the fully connected layers FC 410, 420, 430, and 450, the multiplier 421 and 422, the softmax 411, and the adder 440.

$${h}_{i} = LayerNorm ( FC ( {σ}_{fi} * FC ( {f}_{i} ) + {σ}_{gi} * FC ( {g}_{i} ) ) \qquad Equation 1$$

Referring to equation 1, σ_{*i}=softmax (FC(gᵢ)), * represents f and g, fᵢ represents each level feature or a highest level feature, gᵢ represents a higher level feature of each level feature or a second initial style feature, and FC represents full connection.

In an example, in the BFR method, gᵢ may be processed with a two-dimensional vector z₁, z₂ by performing the full connection for gᵢ, and thus,

$${σ}_{fi} = softmax ( {z}_{1} ) = \frac{{e}^{{z}_{1}}}{{\sum }_{j = 1}^{2} {e}^{{z}_{j}}}$$

$$and$$

$${σ}_{gi} = softmax ( {z}_{2} ) == \frac{{e}^{{z}_{2}}}{{\sum }_{j = 1}^{2} {e}^{{z}_{j}}} .$$

In summary, the FIM may control the degree to which the style feature and the pyramid feature are expressed at each level, and the summation weights may be different for different input images and all level features, and therefore, more flexible and better modulation may be implemented compared to simple cascading and addition.

Hereinabove, the face restoration method according to an example has been described with reference to FIGS. 1 to 4. Hereinafter, a BFR apparatus, an electronic device, and a storage medium according to an example will be described.

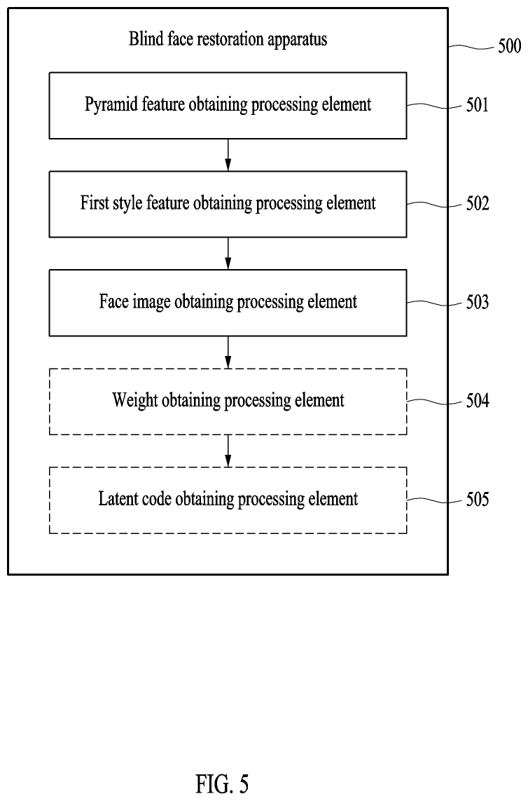

FIG. 5 illustrates an example apparatus for restoring a blind face according to one or more embodiments.

Referring to FIG. 5, in a non-limiting example, a BFR apparatus 500 may include a pyramid feature obtaining processing element 501, a first style feature obtaining processing element 502, and a face image obtaining processing element 503. The BFR apparatus 500 may also include a weight obtaining processing element 504 and a latent code processing element 505.

The BFR apparatus 500 may further include other components, or at least one of the components included in the BFR apparatus may be omitted. Also, the components of the BFR apparatus 500 may be divided or combined. For example, the first style feature obtaining processing element 502 may be divided into two or more processors, and the two or more processors may implement a function of the first style feature obtaining processing element 502. For example, the pyramid feature obtaining processing element 501 and the first style feature obtaining processing element 502 may be combined into one processing element, and the combined processing element may implement functions of both the pyramid feature obtaining processing element 501 and the first style feature obtaining processing element 502.

In an example, the pyramid feature obtaining processing element 501 may obtain a pyramid feature of an input face image.

In an example, the first style feature obtaining processing element 502 may generate a first initial style feature corresponding to a highest level feature based on the highest level feature of the pyramid feature, and a latent code and noise of the input face image, and generate a first style feature corresponding to each level feature based on an integrated feature corresponding to each level feature of the pyramid feature, the noise, and the latent code. Then, the integrated feature corresponding to each level feature may be generated based on each level feature, the first style feature corresponding to a higher level feature of each level feature, the latent code, and noise. Also, the integrated feature corresponding to the highest level feature of the pyramid feature may be generated based on the highest level feature, the latent code, the noise, and the first initial style feature.

According to an example, the face image obtaining processing element 503 may generate a high-quality face image of an input face image based on the first initial style feature and the first style feature corresponding to all level features of the pyramid feature.

According to an example, the BFR apparatus 500 may further include a second style feature obtaining processing element (not shown). The second style feature obtaining processing element may generate a second style feature corresponding to the higher level feature based on the first style feature corresponding to the higher level feature, the noise, and the latent code, generate the integrated feature corresponding to each level feature based on the second style feature corresponding to the higher level feature, and each level feature, generate a second initial style feature corresponding to the highest level feature based on the first initial style feature corresponding to the highest level feature, the latent code, and the noise, and generate the integrated feature corresponding to the highest level feature based on the second initial style feature and the highest level feature.

In an example, the second style feature obtaining processing element may generate a first fully connected feature of the second style feature corresponding to the higher level feature and a first fully connected feature of each level feature by performing a full connection for each of the second style feature corresponding to the higher level feature, and each level feature, generate a first feature by performing first weighted summation of the first fully connected feature of the second style feature corresponding to the higher level feature and the first fully connected feature of each level feature, generate a second feature by performing the full connection for the first feature, generate the integrated feature corresponding to each level feature based on the second feature, generate a first fully connected feature of the second initial style feature and a first fully connected feature of the highest level feature by performing the full connection for each of the second initial style feature and the highest level feature, generate a third feature by performing second weighted summation of the first fully connected feature of the second initial style feature and the first fully connected feature of the highest level feature, generate a fourth feature by performing the full connection for the third feature, and obtain and/or generate the integrated feature corresponding to the highest level feature based on the fourth feature.

In an example, a weight of the first weighted summation for generating the first feature may be obtained based on the second style feature corresponding to the higher level feature, and a weight of the second weighted summation for generating the third feature may be obtained based on the second initial style feature.

In an example, the BFR apparatus 500 may further include a weight obtaining processing element 504. The weight obtaining processing element 504 may generate the weight of the first weighted summation by performing a softmax operation for the first fully connected feature corresponding to the second style feature corresponding to the higher level feature, and generate the weight of the second weighted summation by performing the softmax operation for a second fully connected feature corresponding to the second initial style feature.

In an example, the face image obtaining processing element 503 may obtain an RGB image corresponding to each level feature based on the first style feature corresponding to each level feature of the pyramid feature, obtain an initial RGB image corresponding to the highest level feature based on the first initial style feature, and generate a cumulative RGB image corresponding to each level feature by summing the RGB image corresponding to each level feature and an upscaled RGB image corresponding to the higher level feature of each level feature. Here, the upscaled RGB image corresponding to each level feature may be generated by upscaling the cumulative RGB image corresponding to each level feature. A cumulative RGB image corresponding to the highest level feature may be generated by summing an RGB image corresponding to the highest level feature and an image generated by upscaling the initial RGB image corresponding to the highest level feature. In addition, a cumulative RGB image corresponding to a lowest level feature may be a high-quality image.

In an example, the BFR apparatus 500 may further include a latent code obtaining processing element 505 configured to generate the latent code by performing convolution and full connection for the highest level feature.

In an example, the BFR apparatus 500 may be composed of an electronic device (e.g., electronic apparatus 600 of FIG. 6). As discussed in greater detail below with respect to FIG. 6, the electronic device may include a memory storing one or more instructions, and a processor configured to perform a BFR method according to the present disclosure by executing the one or more instructions.

FIG. 6 illustrates an electronic apparatus according to one or more embodiments.

Referring to FIG. 6, in a non-limiting example, an electronic apparatus 600 according to one embodiment may include a processor 610, a memory 620, and an input device 630. In an example, the electronic apparatus 600 may be a vehicle or an ADS or ADAS of such a vehicle, though examples are not limited thereto. For example, the electronic device 600 may be, or included in, a portable communication terminal (e.g., a mobile phone), a smartphone, tablet personal computer (PC), a wearable device, a medical device, an Internet of Thing (IoT) device, a PC, a laptop, a server, a media player, or a vehicle device (e.g., a navigation system device).

The processor 610 (or processors) may execute instructions (e.g., code and/or programs), and/or may control other operations or functions of the electronic apparatus 600 and operations of the BFR apparatus (e.g., BFR apparatus 500), and may include any one or a combination of two or more of, for example, a central processing unit (CPU), a graphic processing unit (GPU), a neural processing unit (NPU) and tensor processing units (TPUs), but is not limited to the above-described examples. The processor 610 may include the processing elements. The processor 610 may perform blind face recognition. In an example, the processor 610 may restore a low-quality face image by using a pyramid feature extraction, style features, latent code, and noise to generate a high-quality face image while preserving facial identity.

The memory 620 may include computer-readable instructions. The processor 610 may be configured to execute computer-readable instructions, such as those stored in the memory 620, and through execution of the computer-readable instructions, the processor 610 is configured to perform one or more, or any combination, of the operations and/or methods described herein.

In addition, the memory 620 may store various pieces of information generated during the processing process of the processor 610 described above. In addition, the memory 620 may store a variety of data and programs. The memory 620 may include volatile memory or non-volatile memory. The memory 620 may include a high-capacity storage medium such as a hard disk to store a variety of data. The input device 630 may receive an input from a user through traditional input methods such as a keyboard and a mouse, and through new input methods such as a touch input, a voice input, and an image input. For example, the input device 630 may include a keyboard, a mouse, a touch screen, a microphone, or any other device that detects an input from the user and transmits the detected input to the electronic device 630. In an example, the input device may receive images related to blind face restoration from a camera, from memory 620, from an associated device and/or processors including processor 610. However, examples are not limited thereto.

The neural networks, models, processing elements, processors, memories, input devices, electronic apparatuses, face restoring apparatus 200, pyramid feature obtaining model 210, latent code obtaining model 220, noise model 230, style feature obtaining model 240, RGB image obtaining model 250, upscaling and accumulation model 260, feature integration models 321 and 322, style convolution layers (i.e., STC's 310, 311, 312, 313, 314, and 315), fully connected layers (i.e., FC's 410, 420, 430, 440, and 450), BFR apparatus 500, pyramid feature obtaining processing element 501, first style feature obtaining processing element 502, a face image obtaining processing element 503, weight obtaining processing element 504, a latent code processing element 505, electronic apparatus 600, processor 610, memory 620, and input device 630 described herein and disclosed herein described with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
obtaining a pyramid feature of an input face image;
generating a first initial style feature corresponding to a highest level feature based on the highest level feature of the pyramid feature, and a latent code and noise of the input face image;
generating a first style feature corresponding to each level feature based on an integrated feature corresponding to each level feature of the pyramid feature, the noise, and the latent code; and
generating a high-quality face image of the input face image based on the first initial style feature and the first style feature corresponding to each level feature of the pyramid feature,
wherein the integrated feature corresponding to each level feature is generated based on each level feature, the first style feature corresponding to a higher level feature of each level feature, the latent code, and the noise, and
wherein an integrated feature corresponding to the highest level feature of the pyramid feature is generated based on the highest level feature, the latent code, the noise, and the first initial style feature.

2. The method of claim 1, further comprising:
generating a second style feature corresponding to the higher level feature based on the first style feature corresponding to the higher level feature, the noise, and the latent code;
generating the integrated feature corresponding to each level feature based on the second style feature corresponding to the higher level feature, and each level feature; and
generating a second initial style feature corresponding to the highest level feature based on the first initial style feature, the latent code, and the noise, and generating the integrated feature corresponding to the highest level feature based on the second initial style feature and the highest level feature.

3. The method of claim 2, wherein the generating of the integrated feature corresponding to each level feature based on the second style feature corresponding to the higher level feature, and each level feature comprises:
generating a first fully connected feature of the second style feature corresponding to the higher level feature and a first fully connected feature of each level feature by performing a full connection for each of the second style feature corresponding to the higher level feature, and each level feature;
generating a first feature by performing first weighted summation of the first fully connected feature of the second style feature corresponding to the higher level feature and the first fully connected feature of each level feature;
generating a second feature by performing the full connection for the first feature; and
generating the integrated feature corresponding to each level feature based on the second feature, and
wherein the generating of the integrated feature corresponding to the highest level feature based on the second initial style feature and the highest level feature comprises:
generating a first fully connected feature of the second initial style feature and a first fully connected feature of the highest level feature by performing the full connection for each of the second initial style feature and the highest level feature;
generating a third feature by performing second weighted summation of the first fully connected feature of the second initial style feature and the first fully connected feature of the highest level feature;
generating a fourth feature by performing the full connection for the third feature; and
obtaining the integrated feature corresponding to the highest level feature based on the fourth feature.

4. The method of claim 3, wherein a first weight of the first weighted summation for generating the first feature is obtained based on the second style feature corresponding to the higher level feature, and
wherein a second weight of the second weighted summation for generating the third feature is obtained based on the second initial style feature.

5. The method of claim 4, further comprising:
generating the first weight by performing a softmax operation for the first fully connected feature corresponding to the second style feature corresponding to the higher level feature; and
generating the second weight by performing the softmax operation for a second fully connected feature corresponding to the second initial style feature.

6. The method of claim 1, wherein the generating of the high-quality face image of the input face image based on the first initial style feature and the first style feature corresponding to each level feature of the pyramid feature comprises:
obtaining a red, green, blue (RGB) image corresponding to each level feature based on the first style feature corresponding to each level feature of the pyramid feature, and obtaining an initial RGB image corresponding to the highest level feature based on the first initial style feature; and
generating a cumulative RGB image corresponding to each level feature by summing the RGB image corresponding to each level feature and an upscaled RGB image corresponding to the higher level feature of each level feature,
wherein a cumulative RGB image corresponding to a lowest level feature is a high-quality image,
wherein the upscaled RGB image corresponding to each level feature is generating by upscaling the cumulative RGB image corresponding to each level feature, and
wherein a cumulative RGB image corresponding to the highest level feature is generating by summing an RGB image corresponding to the highest level feature and an image obtained by upscaling the initial RGB image corresponding to the highest level feature.

7. The method of claim 1, further comprising:
generating the latent code by performing convolution and full connection for the highest level feature.

8. A non-transitory, computer-readable storage medium storing instructions that, in response to being executed by a processor, cause the processor to perform the method of claim 1.

9. An apparatus, the apparatus comprising:
a pyramid feature obtaining processing element configured to obtain a pyramid feature of an input face image;
a first style feature obtaining processing element configured to generate a first initial style feature corresponding to a highest level feature based on the highest level feature of the pyramid feature, and a latent code and noise of the input face image, and generate a first style feature corresponding to each level feature based on an integrated feature corresponding to each level feature of the pyramid feature, the noise, and the latent code; and
a face image obtaining processing element configured to generate a high-quality face image of the input face image based on the first initial style feature and the first style feature corresponding to each level feature of the pyramid feature,
wherein the integrated feature corresponding to each level feature is obtained based on each level feature, the first style feature corresponding to a higher level feature of each level feature, the latent code, and the noise, and
wherein an integrated feature corresponding to the highest level feature of the pyramid feature is generated based on the highest level feature, the latent code, the noise, and the first initial style feature.

10. The apparatus of claim 9, further comprising:
a second style feature obtaining processing element configured to:
generate a second style feature corresponding to the higher level feature based on the first style feature corresponding to the higher level feature, the noise, and the latent code;
generate the integrated feature corresponding to each level feature based on the second style feature corresponding to the higher level feature, and each level feature;
generate a second initial style feature corresponding to the highest level feature based on the first initial style feature, the latent code, and the noise; and
generate the integrated feature corresponding to the highest level feature based on the second initial style feature and the highest level feature.

11. The apparatus of claim 10, wherein the second style feature obtaining processing element is configured to:
generate a first fully connected feature of the second style feature corresponding to the higher level feature and a first fully connected feature of each level feature by performing a full connection for each of the second style feature corresponding to the higher level feature, and each level feature;
generate a first feature by performing first weighted summation of the first fully connected feature of the second style feature corresponding to the higher level feature and the first fully connected feature of each level feature;
generate a second feature by performing the full connection for the first feature;
generate the integrated feature corresponding to each level feature based on the second feature, generate a first fully connected feature of the second initial style feature and a first fully connected feature of the highest level feature by performing the full connection for each of the second initial style feature and the highest level feature;
generate a third feature by performing second weighted summation of the first fully connected feature of the second initial style feature and the first fully connected feature of the highest level feature;
generate a fourth feature by performing the full connection for the third feature; and
obtain the integrated feature corresponding to the highest level feature based on the fourth feature.

12. The apparatus of claim 11, wherein a first weight of the first weighted summation for generating the first feature is obtained based on the second style feature corresponding to the higher level feature, and
wherein a second weight of the second weighted summation for obtaining the third feature is obtained based on the second initial style feature.

13. The apparatus of claim 12, further comprising:
a weight obtaining processing element configured to:
generate the first weight by performing a softmax operation for the first fully connected feature corresponding to the second style feature corresponding to the higher level feature; and
generate the second weight by performing the softmax operation for a second fully connected feature corresponding to the second initial style feature.

14. The apparatus of claim 9, wherein the face image obtaining processing element is configured to:
obtain a red, green, blue (RGB) image corresponding to each level feature based on the first style feature corresponding to each level feature of the pyramid feature;
generate an initial RGB image corresponding to the highest level feature based on the first initial style feature; and
generate a cumulative RGB image corresponding to each level feature by summing the RGB image corresponding to each level feature and an upscaled RGB image corresponding to the higher level feature of each level feature,
wherein a cumulative RGB image corresponding to a lowest level feature is a high-quality image,
wherein the upscaled RGB image corresponding to each level feature is generated by upscaling the cumulative RGB image corresponding to each level feature, and
wherein a cumulative RGB image corresponding to the highest level feature is generated by summing an RGB image corresponding to the highest level feature and an image generated by upscaling the initial RGB image corresponding to the highest level feature.

15. The apparatus of claim 9, further comprising:
a latent code obtaining processing element configured to generate the latent code by performing convolution and full connection for the highest level feature.

16. An electronic device, comprising:
one or more processors configured to execute instructions; and
a memory storing the instructions, wherein execution of the instructions configures the processors to:
obtain a pyramid feature of an input face image;
generate a first initial style feature corresponding to a highest level feature based on the highest level feature of the pyramid feature, and a latent code and noise of the input face image;
generate a first style feature corresponding to each level feature based on an integrated feature corresponding to each level feature of the pyramid feature, the noise, and the latent code; and
generate a high-quality face image of the input face image based on the first initial style feature and the first style feature corresponding to each level feature of the pyramid feature,
wherein the integrated feature corresponding to each level feature is generated based on each level feature, the first style feature corresponding to a higher level feature of each level feature, the latent code, and the noise, and
wherein an integrated feature corresponding to the highest level feature of the pyramid feature is generated based on the highest level feature, the latent code, the noise, and the first initial style feature.
